(19) United States
(12) Patent Application Publication
(10) Pub. No.: US 2024/0256720 A1
(43) Pub. Date: Aug. 1, 2024

(54) SPATIAL DECOMPOSITION-BASED INFILLS OF UNIT CELL DESIGNS FOR COMPUTER-AIDED DESIGN (CAD) OBJECTS

(71) Applicant: Siemens Industry Software Inc., Plano, TX (US)

(72) Inventor: Hiren Dedhia, Santa Ana, CA (US)

(73) Assignee: Siemens Industry Software Inc., Plano, TX (US)

(21) Appl. No.: 18/561,032

(22) PCT Filed: May 28, 2021
(86) PCT No.: PCT/US2021/034770

§ 371 Date: Nov. 15, 2023

(51) Int. Cl. G06F 30/10; G06F 111/10

(52) U.S. Cl. CPC G06F 30/10; G06F 2111/10

(57) ABSTRACT

A computing system may include a decomposition engine configured to access a unit cell design and a fill region of a computer-aided design object to infill with instances of the unit cell design and spatially decompose the fill region into power-of-two boxes. The power-of-two boxes may have dimensions equal to dimensions of the unit cell design multiplied by a power of two. The computing system may also include an infill engine configured to infill the fill region by performing a joining operation of aggregated bodies based on the spatial decomposition of the fill region. Each given aggregated body may comprise a number of unit cell designs equal to a power of two that are joined together to form the given aggregated body.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports spatial decomposition-based infills of unit cell designs for CAD objects.

FIG. 2 shows an example spatial decomposition of a fill region by a decomposition engine.

FIG. 3 shows an example determination of unit cell counts for different dimensions of a fill region.

FIG. 4 shows an example computation of an upper power-of-two value from determined unit cell counts for a fill region as well as generation of power-of-two boxes and aggregated bodies based on the upper power-of-two value.

FIG. 5 shows an example spatial decomposition of a fill region via a spatial decomposition tree.

FIG. 6 shows an example generation of an infill design through a spatially decomposed infill region represented as a spatial decomposition tree.

FIG. 7 shows an example of logic that a system may implement to support spatial decomposition-based infills of unit cell designs for CAD objects.

FIG. 8 shows an example of a computing system that supports spatial decomposition-based infills of unit cell designs for CAD objects.

### DETAILED DESCRIPTION

Additive manufacturing (sometimes referred to as 3-dimensional or 3D printing) may be performed through use of 3D printers that can construct objects on a layer-by-layer basis. Through increasing additive manufacturing capabilities, manufacture of arbitrary and complex product designs has become increasing possible. Within a given design space, previous manufacturing limitations have become overcome through additive manufacturing, and product designers now have increasing design freedoms that support optimization of manufactured objects. Moreover, additive manufacture can enable the manufacturing of parts with unique physical properties through design or control of the part's geometric structure, including the design of micro-structures that form an internal geometry of the object design.

For objects designed for construction via additive manufacturing (and otherwise), repeating designs such as lattice structures can provide a light-weight and efficient mechanism to form internal geometries of object designs to meet certain physical or geometric properties. Repeating designs may be generated for 1D, 2D, or 3D patterns using unit cell designs repeated across a fill space. For such repeating designs, however, instantiation of a design geometry based on a repeating design element can consume significant computing resources. In some instances, infill of a region of a CAD object can be performed based on a unit cell design in which instances of the unit cell design are repeated across the fill region. As used herein, infill operations may refer to generation of any 1D, 2D, or 3D CAD geometry, whether as an internal geometry enclosed by CAD surfaces, surface structures that overlay the exterior of a CAD object, or any other suitable scenario in which repeating unit cell designs are used to generate, instantiate, or design any geometry of a CAD object.

For CAD objects represented as boundary representations (B-Reps), geometric representations, visual models, or in other visual forms, performing an infill of a CAD object region may require that a separate joining operation (e.g., boolean operation) be performed to join each separate instance of the unit cell design together to form the infilled design of the CAD object. Such joining operations can be slow and computationally intensive, as brute force stitching of individual unit cell designs together may require collision evaluations between each separate instance of the unit cell designs used to infill a design space. In particular, brute force joining operations may require intersection computations between each combination of faces for each of the unit cell designs used to infill a CAD object. The computational complexity of such a naive infill algorithm may be O(n*m), in which n is the number of unit cell designs (e.g., instances thereof) used to infill the fill region and m is the number of faces in the unit cell design repeated across the fill region. Such computational complexity may be untenable if even only a moderate number of unit cell design instances are used to infill a region, and infill of any relatively large CAD spaces or surfaces may require impractical or untenable amounts of computing resources, processing time, or both.

The disclosure herein may provide systems, methods, devices, and logic for spatial decomposition-based infills of unit cell designs for CAD objects. The spatial decomposition-based infill technology described herein may provide capabilities to spatially decompose a fill region to infill with instances of a unit cell design. Instead of individually stitching together each instance of a unit cell design as with conventional brute force infill algorithms, the spatial decomposition-based infill technology described herein may partition the fill region into power-of-two boxes. Power-of-two boxes may have dimensions equal to dimensions of the unit cell design multiplied by a power of two, e.g., multiplied by 2 (i.e., 2¹), 4 (i.e., 2²), 8 (i.e., 2³), 16 (i.e., 2⁴), and so forth. Infill of the fill region may be performed based on the spatial decomposition by performing a joining operation of aggregated bodies that cover the power-of-two boxes in the decomposed fill region. Each given aggregated body may include a number of unit cell designs equal to a power of two that are joined together to form the given aggregated body. Joining operations to generate aggregated bodies need only be performed once, even when multiple instances of the aggregated body are used in the infill operations.

In these ways and more, the spatial decomposition-based infill technology described herein may perform a lesser number of joining operations for the unit cell designs as compared to conventional techniques. The generation of the aggregated bodies of unit cell designs through joining operations need only be performed a single time for each different size of the aggregated bodies, e.g., an aggregated body with 4 instances of the unit cell design joined together and that corresponds to a power-of-two box with dimensions equal to the dimensions of a unit cell design multiplied by 2 (i.e., 2¹), an aggregated body with 16 instances of the unit cell design joined together and that corresponds to a power-of-two box with dimensions equal to the dimensions of a unit cell design multiplied by 4 (i.e., 2²), and so forth. Then, additional joining operations can be performed to infill the fill region with aggregated bodies (and unit cell design) based on a number of power-of-two boxes used to spatially decompose the fill region.

Such spatial decomposition-based infill techniques may provide an infilled CAD design output identical with naive joining operations, but require a lesser number joining operations since the aggregated bodies need only be joined once for each different size. As such, the spatial decomposition-based infill technology described herein may perform infill operations for CAD objects with increased efficiency, improving the performance of CAD systems as compared to brute force approaches. Moreover, performance improvements may further increase for CAD objects with increasingly large fill regions, as the efficiency benefits from spatial decompositions via power-of-two boxes may result in increasingly less join operations over larger fill spaces.

These and other spatial decomposition-based infill features and technical benefits are described in greater detail herein.

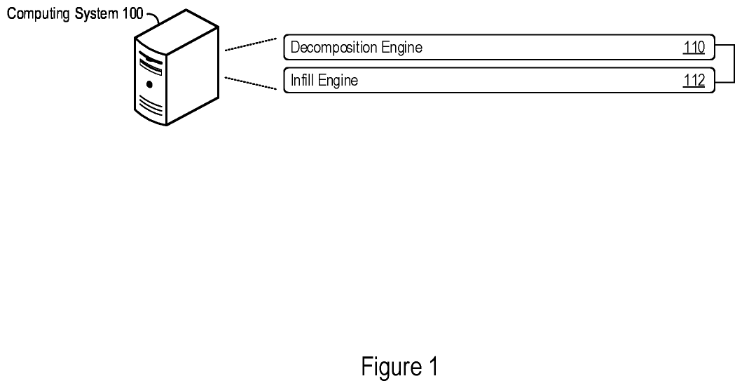

FIG. 1 shows an example of a computing system 100 that supports spatial decomposition-based infills of unit cell designs for CAD objects. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a CAD application that supports infill operations of unit cell designs for designated fill regions of CAD objects.

As an example implementation to support any combination of the model explosion features described herein, the computing system 100 shown in FIG. 1 includes a decomposition engine 110 and an infill engine 112. The computing system 100 may implement the engines 110 and 112 (including components thereof) in various ways, for example as hardware and programming. The programming for the engines 110 and 112 may take the form of processor-executable instructions stored on a non-transitory machine-readable storage medium and the hardware for the engines 110 and 112 may include a processor to execute those instructions. A processor may take the form of single processor or multi-processor systems, and in some examples, the computing system 100 implements multiple engines using the same computing system features or hardware components (e.g., a common processor or a common storage medium).

In operation, the decomposition engine 110 may access a unit cell design and a fill region of a CAD object to infill with instances of the unit cell design as well as spatially decompose the fill region into power-of-two boxes, in which the power-of-two boxes may have dimensions equal to dimensions of the unit cell design multiplied by a power of two. In operation, the infill engine 112 may infill the fill region by performing a joining operation of aggregated bodies based on the spatial decomposition of the fill region. Each given aggregated body may include a number of unit cell designs equal to a power of two that are joined together to form the given aggregated body.

These and other spatial decomposition-based infill features and technical benefits are described in greater detail next. For visual clarity, many of the examples presented herein are in the context of 2D unit cell designs and fill regions. However, the spatial decomposition-based infill features are not so limited, and the spatial decomposition-based technology described herein may be consistently applied for unit cell designs and fill regions of any dimension, including 1D and 3D unit cell designs and fill regions of CAD objects.

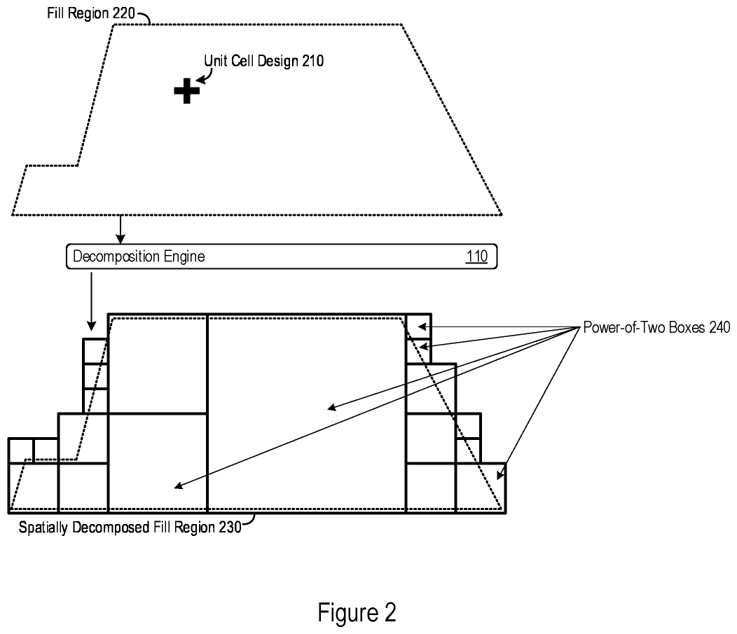

FIG. 2 shows an example spatial decomposition of a fill region by the decomposition engine 110. In the example of FIG. 2, the decomposition engine 110 accesses a unit cell design 210 and a fill region 220. The unit cell design 210 may be any 1D, 2D, or 3D design element that can be instantiated across the fill region 220. In that regard, a CAD application may support infilling of the fill region 220 with a pattern comprised of repeating instances of the unit cell design 210, and the decomposition engine 110 may support such infilling by spatially decomposing the fill region 220 based on the unit cell design 210.

The decomposition engine 110 may access the unit cell design 210 in various ways. For example, an application user may input, design, or select a particular CAD element to use as the unit cell design 210, and some CAD systems may provide unit cell libraries storing varieties of unit cell designs selectable to infill CAD object fill regions. The unit cell design 210 may, as one example, take the form of a ball and rod(s), and repeating instances of the unit cell design 210 across the fill region 220 may form an internal lattice structure of a CAD object. The number of designs that the unit cell design 210 can encompass can be immense, and the unit cell design 210 may take any form, geometry, or shape, and may be 1D, 2D, or 3D. The fill region 220 may be specified by a CAD application user as well, or may be otherwise identified, designed, configured selected, or specified by a CAD application as a designated portion of a CAD object to infill with the unit cell design 210.

The decomposition engine 110 may spatially decompose the fill region 220 to generate the spatially decomposed fill region 230. As used herein, spatial decomposition may refer to any process or technique by which a fill region is partitioned into different sections based on characteristics of the fill region. Although depicted visually in FIG. 2, the decomposition engine 110 may represent the spatially decomposed fill region 230 in any number of ways. For example, the decomposition engine 110 may spatially decompose the fill region 220 or represent the spatially decomposed fill region 230 via a spatial structure, such as a spatial decomposition tree. Generation of a spatial decomposition tree, for example through iterative processing of tree nodes, may be one way in which the decomposition engine 110 spatially decomposes the fill region 220. In such examples, different partitions of the fill region 220 can be mapped to specific locations (e.g., nodes) of the spatial decomposition tree. Then, an infill operation for the fill region 220 can be performed leveraging the spatial data stored in the spatial decomposition tree or any other suitable spatial structure.

In the example shown in FIG. 2, the decomposition engine 110 spatially decomposes the fill region 220 into various partitions in the form of power-of-two boxes 240. A power-of-two box may refer to a shape that has dimensions equal to dimensions of the unit cell design 210 multiplied by a power of two, e.g., multiplied by 2 (i.e., 2¹), 4 (i.e., 2²), 8 (i.e., 2³), 16 (i.e., 2⁴), and so forth. The unit cell design 210, or a box surrounding the unit cell design as described herein, may likewise be considered a power-of-two box, as it has dimensions equal to itself multiplied by 1 (i.e., 2⁰). To spatially decompose the fill region 220, generate the spatially decomposed fill region 230, or otherwise represent the spatially decomposed fill region 230, the decomposition engine 110 may process the fill region 220 based on the unit cell design 210. Example processing features according to the spatial decomposition-based infill technology of the present disclosure are described next.

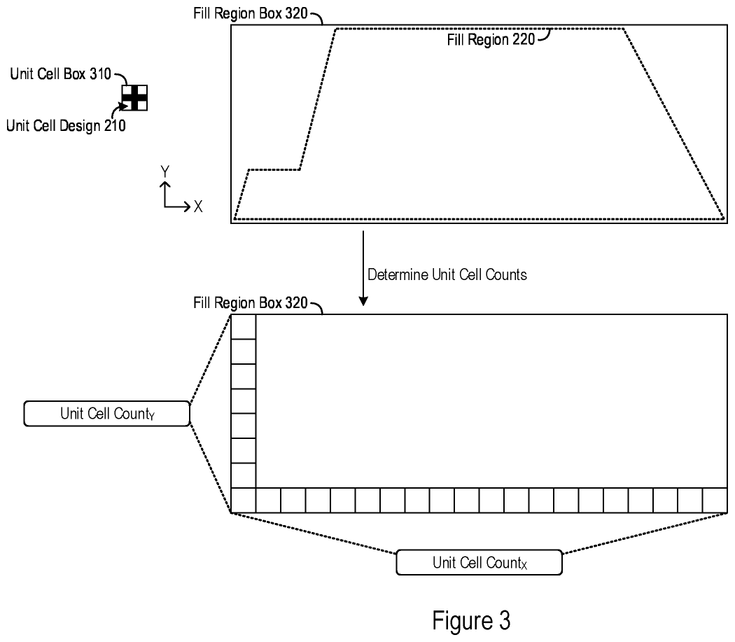

FIG. 3 shows an example determination of unit cell counts for different dimensions of a fill region. A unit cell count may refer to a number of instances of a unit cell design needed to infill a particular dimension of a fill region, and the decomposition engine 110 may determine unit cell counts for fill regions. The example features in FIG. 3 are described through a continuing example of the unit cell design 210 and the fill region 220 presented in FIG. 2, and the unit cell count determination features of FIG. 3 are described via the decomposition engine 110 as an example implementation, though any suitable implementations are contemplated herein.

In the example of FIG. 3, the decomposition engine 110 determines unit cell counts based on the unit cell design 210 and for an X-dimension and a Y-dimension for the fill region 220. In some implementations, the decomposition engine 110 may determine unit cell counts based on boxes that surround the unit cell design 210 and the fill region 220. In FIG. 3, the decomposition engine 110 identifies, determines, or configures the unit cell box 310 that surrounds the unit cell design 210 and the fill region box 320 that surrounds the fill region 220. The surrounding boxes of a unit cell design and fill region may match the dimensionality of the unit cell design and fill region. Thus, the unit cell box 310 and fill region box 320 in FIG. 3 are both 2D, as both the unit cell design 210 and fill region 220 are 2D as well. Such surrounding boxes may be 1D or 3D in situations in which the unit cell design and fill region are 1D or 3D, respectively.

The decomposition engine 110 may determine the unit cell box 310 as a surrounding box that precisely surrounds the unit cell design 210. For instance, the decomposition engine 110 may configure, identify, or set the unit cell box as a surrounding box that directly aligns with the furthest borders, edges, or extensions of the unit cell design 210. As another implementation option, the decomposition engine 110 may determine the unit cell box 310 as the minimum-sized box that completely encloses the unit cell design 210. The precise alignment of the unit cell box 310 to the unit cell design 210 may reflect the instantiating and joining of instances of the unit cell design 210 in order to infill the fill region 220. The unit cell box 310 may thus align, reflect, or correspond to the size and dimension of individual instances of the unit cell design 210 joined to infill the fill region 220, and may thus be used to track or designate placements of individual instances of the unit cell design 210 in the fill region 220.

In generating the fill region box 320, the decomposition engine 110 may also identify a surrounding box that precisely surrounds the fill region 220. In other implementations, the decomposition engine 110 may configure the fill region box 320 to have a slight space buffer that extends beyond the fill region 220, for example to ensure that each dimension value of the fill region box 320 is an exact multiple of a corresponding dimension value of the unit cell box 310 determined for the unit cell design 210. The decomposition engine 110 may construct, set, or generate the unit cell box 310, the fill region box 320, or both, as rectangular shapes with specified dimension values based on the unit cell design 210 and fill region 220 respectively.

The decomposition engine 110 may determine unit cell counts for each dimension of the fill region box 320 that encloses the fill region 220. In some implementations, the decomposition engine 110 may determine the unit cell count of a particular dimension of the fill region box 320 as a function of dimension values of the fill region box 320 and the unit cell box 310. In one example, the decomposition engine 110 may compute a unit cell count as the dimension value of the fill region box 320 for a particular dimension divided by the dimension value of the unit cell box 310 for the particular dimension. The fill region box 320 depicted in FIG. 3 is 2D and thus includes X and Y-dimension values, so the decomposition engine 110 may determine unit cell counts for the X and Y-dimension of the fill region box 320, shown in FIG. 3 and also referred to herein as unit cell count_{X} and unit cell county. As one example, the decomposition engine 110 may compute unit cell count_{X} via the following function:

$$Unit Cell {Count}_{X} = \frac{Fill Region {Box}_{X}}{Unit Cell {Box}_{X}}$$

In this example, Fill Region Box_{X} represents X-dimension value of the fill region box 320 and Unit Cell Box_{X} represents the X-dimension value of the unit cell box 310. The decomposition engine 110 may implement or perform a similar function to compute unit cell counts for any other dimension of the fill region 220, for example to compute unit cell county. As noted herein, unit cell count_{X} of the fill region 220 may represent or indicate a number of instances of the unit cell design 210 to infill the X-dimension of the fill region 220.

In the example shown in FIG. 3, the decomposition engine 110 computes unit cell count_{X} to be a value 20 (as shown and represented in FIG. 3 by the twenty (20) unit cell boxes needed to infill the X-dimension of the fill region box 320). When the decomposition engine 110 sets the dimensions of the fill region box 320 to be exact multiples of corresponding dimensions of the unit cell box 310, unit cell count determinations by the decomposition engine 110 may result in integer values. For non-exact dimension multiples, the decomposition engine 110 may determine non-integer values for unit cell counts (or, alternatively, apply a ceiling function to the non-integer values). In a consistent manner, the decomposition engine 110 may compute unit cell county for the fill region 220. In the example of FIG. 3, the decomposition engine 110 determines a value of 8 for the unit cell county (as shown and represented in FIG. 3 by the eight (8) unit cell boxes needed to infill the Y-dimension of the fill region box 320).

The decomposition engine 110 may utilize the unit cell counts determined for a fill region 220 to determine what size power-of-two boxes are required to spatially decompose the fill region 220. Such determinations may include computation of an upper power-of-two value, as described next.

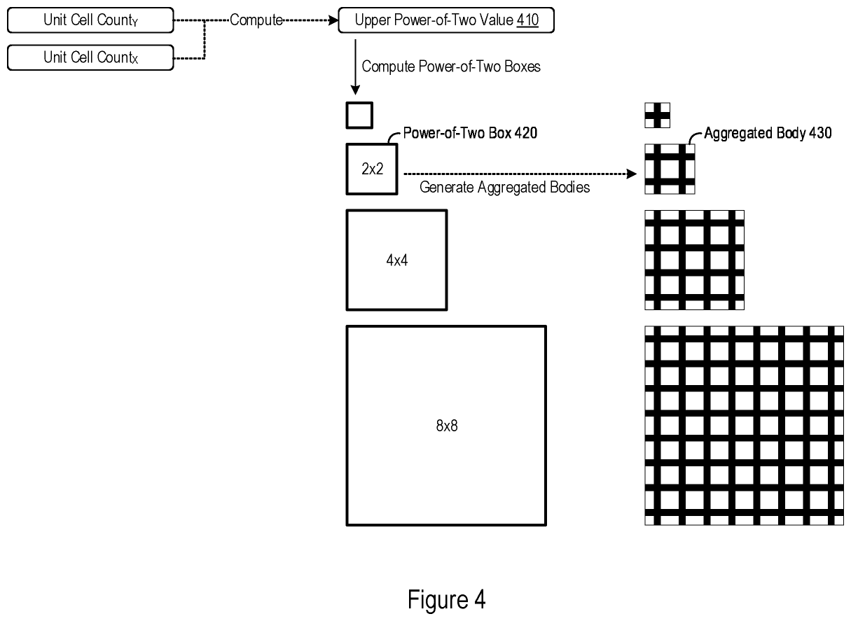

FIG. 4 shows an example computation of an upper power-of-two value from determined unit cell counts for a fill region as well as generation of power-of-two boxes and aggregated bodies based on the upper power-of-two value. An upper power-of-two value for a fill region may be any value that represents a largest power-of-two box that can fit in the fill region 220. In the example of FIG. 4, the decomposition engine 110 computes the upper power-of-two value 410 as a function of the unit cell counts determined for the fill region 220 (e.g., unit cell count_{X} with a value of 20 and unit cell county with a value of 8, as described above).

The decomposition engine 110 may represent the upper power-of-two value 410 in various ways. In some implementations, the decomposition engine 110 represents an upper power-of-two value as the exponent of the power of two multiplier for the largest power-of-two box that can fit the fill region 220. For an example largest power-of-two box that has dimensions 8× the dimensions of the unit cell design 210, the decomposition engine 110 may determine an upper power-of-two value as 3, since 8=2³ and the exponent value for this power of two multiplier is 3. For such exponent representations of the upper power-of-two value 410, the decomposition engine 110 may compute the upper power-of-two value 410 according to the following function:

$$p = int ( {log}_{2} ( min [ UC ] ) )$$

In this example function, p represents the upper power-of-two value 410 in this example exponent representation and UC represents the set of unit cell counts computed for the dimensions of the fill region 220. In the continuing example presented herein for the fill region 220 in which unit cell count_{X} has a value of 20 and unit cell county has a value of 8, the decomposition engine 110 may compute the upper power-of-two value 410 in this example exponent representation to be 3 (which corresponds to a power of two value of 8, that is 2³). As alternatives to the above-described exponential representation, the decomposition engine 110 may represent the upper power-of-two value 410 as the power of two value itself (in this example a value of 8, which is 2³), as a number of instances of the unit cell design 210 in the largest power-of-two box (in this case 64, for an 8×8 power-of-two box with each dimension multiplied by 8), or in other ways.

Based on the upper power-of-two value 410 computed for the fill region 220, the decomposition engine 110 may construct the power-of-two boxes that can be used to spatially decompose the fill region 220. Aside from the unit cell box 310 (which itself may be a power-of-two box that is already constructed), the decomposition engine 110 may construct an additional number of power-of-two boxes equal to the upper power-of-two value 410 (in its exponential representation p). Examples of power-of-two boxes that the decomposition engine 110 may generate are shown in FIG. 4, including a 1×1 power-of-two box (which is identical to the unit cell box 310), a 2×2 power-of-two box (also labeled as the power-of-two box 420 in FIG. 4), a 4×4 power-of-two box, and an 8×8 power-of-two box. The decomposition engine 110 may construct each of these power-of-two boxes by determining the dimension(s) of each power-of-two box as a power of two multiple (e.g., 2×, 4×, 8×, 16×, etc.) of the corresponding dimension of the unit cell design 210 (as measured via the unit cell box 310).

As each dimension of a power-of-two box is equal to a corresponding dimension of the unit cell design 210 multiplied by a particular power of two, then it can be understood that the power-of-two box can fit a number of instances of the unit cell design 210 equal to the squared value of the particular power of two. For example, the power-of-two box 420 shown in FIG. 4 with dimensions double (2×) of the dimensions of the unit cell design 210 may fit 2² number of instances of the unit cell design 210. This double-dimension power-of-two box may also be referred to as a 2×2 power-of-two box. In a consistent manner, a power-of-two box shown in FIG. 4 with 4 times (4×) the dimensions of the unit cell design 210 may fit 4² number of instances of the unit cell design 210 (that is, 16 instances), and may be referred to as a 4×4 power-of-two box.

The decomposition engine 110 need only construct power-of-two boxes up to a size as dictated by the upper power-of-two value 410. As the upper power-of-two value 410 may specify, indicate, or reflect a largest size power-of-two box that can fit in the fill region 220, the decomposition engine 110 need not generate any power-of-two box that cannot fit in the fill region 220 as those larger-size power-of-two boxes would be too large to use in spatially decomposing the fill region 220. The decomposition engine 110 may generate power-of-two boxes with dimensions multiplied by each power of two up to the exponent value specified by the upper power-of-two value 410. Thus, the length of each dimension of a power-of-two box for the 0^{th} power of two would be equal to the corresponding dimension of the unit cell design 210 (e.g., as measured by the dimension value of the unit cell box 310). The length of each dimension of a power-of-two box for the 1^{st} power of two would be equal to 2¹ times (i.e., 2×) the corresponding dimension of the unit cell design 210. The length of each dimension of a power-of-two box for the 2^{nd} power of two would be equal to 2² times (i.e., 4×) the corresponding dimension of the unit cell design 210. The length of each dimension of a power-of-two box for the p^{th} power of two would be equal to 2^{p} times the corresponding dimension of the unit cell design 210.

In the continuing example presented herein with a determined upper power-of-value 410 of 3, the decomposition engine 110 may generate power-of-two boxes up to dimensions that are 2³ times (8×) that of the unit cell design 210. As seen in FIG. 4, the decomposition engine 110 generates 1×1, 2×2, 4×4, and 8×8 power-of-two boxes based on the upper power-of-two value 410, and determines not to generate any larger power-of-two boxes as such larger size power-of-two boxes would not be used in spatially decomposing the fill region 220. For example, the decomposition engine 110 need not generate a 16×16 power-of-two box for the fill region 220 since a 16×16 power-of-two box would exceed Y-dimension length of the fill region box 320, and the fill region 220 could not be spatial decomposed using such a 16×16 power-of-two box.

In some implementations, the decomposition engine 110 generates aggregated bodies from the constructed power-of-two boxes (though, as another option, the infill engine 112 may generate the aggregated bodies later in the spatial decomposition-based infill process). The decomposition engine 110 may generate the aggregated bodies for the fill region 220 based on the computed upper power-of-two value 410, as such a value would control generation of the power-of-two boxes. An aggregated body may include joined instances of the unit cell design 210, and the thus the decomposition engine 110 may generate aggregated bodies by performing any type of join (e.g., boolean) operation to combine instances of the unit cell design 210 together. The decomposition engine 110 may generate aggregated bodies that directly correspond to the constructed power-of-two boxes. Thus, in FIG. 4, the decomposition engine 110 generates the aggregated body 430 that joins four (4) instances of the unit cell design 210, and the aggregated body 430 directly correlates to the power-of-two box 420 in that they share the same dimension and size. Both the power-of-two box 420 and the aggregated body 430 have dimensions equal to 2 times the dimensions of the unit cell design 210, and the aggregated body 430 can be understood as the power-of-two box 420 infilled with instances of the unit cell design 210 in a 2×2 manner.

The decomposition engine 110 may generate aggregated bodies in a sequential order, from smaller sizes to larger sizes. For a 1×1 aggregated body, the decomposition engine 110 need not perform any joining operations as the unit cell design 210 itself may serve as the 1×1 aggregated body. For a 2×2 aggregated body (e.g., the aggregated body 430), the decomposition engine 110 may join four (4) instances of the unit cell design 210 together, which may include evaluating face collisions or overlaps and any other relevant computations for CAD joining or boolean operations To generate the 4×4 aggregated body, the decomposition engine 110 need not join sixteen (16) instances of the unit cell design 210, which require a high number of overlap or collision evaluations for each of the individual instances of the unit cell design 210. Instead, the decomposition engine 110 may join four (4) instances of the generated 2×2 aggregated body, which may reduce the computational strain and execution latency in generating the 4×4 aggregated body. In a similar manner, the decomposition engine 110 may generate an 8×8 aggregated body by joining four (4) instances of the 4×4 aggregated body, and so forth for sequentially larger power-of-two boxes.

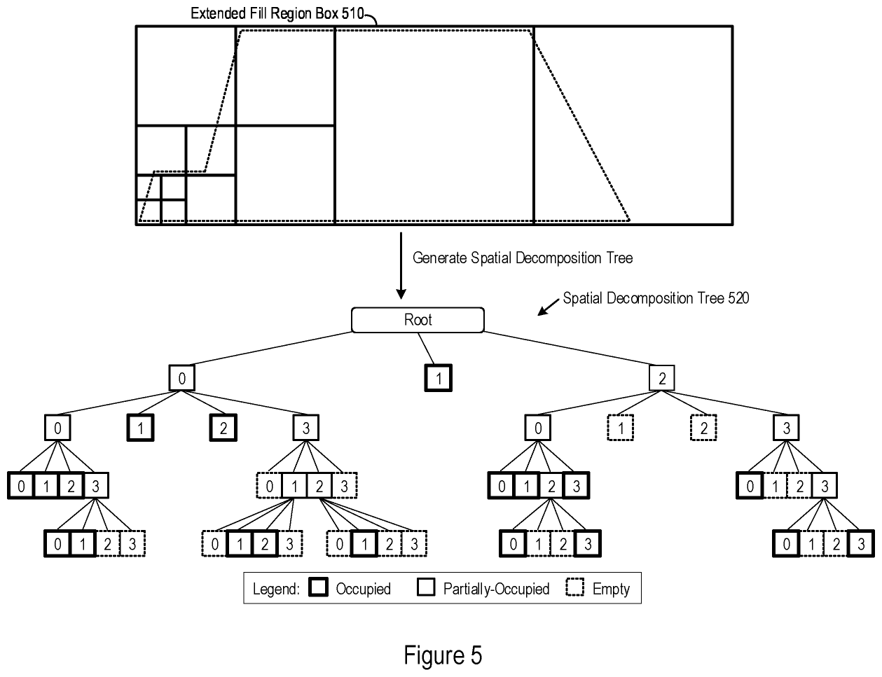

Note that the aggregated bodies may be generated at any time after determination of the upper power-of-two value 410, including after spatial decomposition of the fill region 220 via the constructed power-of-two boxes. Spatial decomposition via power-of-two boxes is described next with reference to FIG. 5.

FIG. 5 shows an example spatial decomposition of a fill region via a spatial decomposition tree. The decomposition engine 110 may decompose a fill region by recursively decomposing space in the fill region via power-of-two boxes, and constructing the spatial decomposition tree to reflect which power-of-two boxes overlap with or are occupied by a designated fill region. While the example in FIG. 5 is presented using a spatial decomposition tree as an example, the decomposition engine 110 may spatially decompose a fill region using any suitable type of spatial structure.

To support spatial deconstruction of a fill region, the decomposition engine 110 may adjust one or more dimensions of a fill region box that surrounds the fill region to form an extended fill region box. The decomposition engine 110 may form the extended fill region box to have dimension sizes that are integer multiples of the largest power-of-two box constructed to spatially decompose the fill region (e.g., as reflected through the upper power-of-two value 410). By forming an extended fill region box, the decomposition engine 110 may ensure a consistent construction of the spatial decomposition tree as the extended fill region box can be partitioned into an integer number of the largest constructed power-of-two box.

To illustrate through FIG. 5, the decomposition engine 110 extends a dimension of the fill region box 320 that surrounds the fill region 220 to form the extended fill region box 510. In particular, the decomposition engine 110 extends an X-dimension value of the fill region box 320 to be an integer multiple of the 8×8 power-of-two box that the decomposition engine 110 determines to be the largest power-of-two box to use to spatially decompose the fill region 220 (as specified by the upper power-of-two value 410). For the continuing example presented here, the unit cell count_{X} determined for the fill region 220 has a value of 20, and the decomposition engine 110 may extend the X-dimension of the fill region box 320 such that the unit cell count_{X} reaches the next integer multiple of the X-dimension of the largest constructed power-of-two box for the spatial decomposition of the fill region 220.

In this example, the decomposition engine 110 extends the X-dimension of the fill region box 320 by four (4) X-dimension values of the unit cell design 210. As such, the decomposition engine 110 may form the extended fill region box 510 such that the unit cell count_{X} of the extended fill region box 510 has a value 2⁴, which is an integer multiple of the X-dimension of the 8×8 power-of-two box. Note that in this continuing example, the decomposition engine 110 need not extend the Y-dimension of the fill region box 320 in forming the extended fill region box 510. This may be the case since the Y-dimension value of the fill region box 320 (with a unit cell county of 8) is an integer multiple of the Y-dimension value of the 8×8 power-of-two box for spatially decomposing the fill region 220. For fill region boxes with Y-dimension values that are not exact integer multiples of the Y-dimension value of the largest power-of-two box used to spatially decompose a fill region, the decomposition engine 110 may extend the Y-dimension of the fill region box in a consistent manner as described herein so that Y-dimension value of the extended fill region box is an integer multiple of the Y-dimension value of the largest power-of-two box used to spatially decompose a fill region.

The decomposition engine 110 may spatially decompose a fill region using the extended fill region box formed for the fill region. In the example of FIG. 5, the decomposition engine 110 generates the spatial decomposition tree 520 by decomposing the extended fill region box 510 via power-of-two boxes and evaluating which power-of-two boxes overlap or are occupied by the fill region 220. In some implementations, the decomposition engine 110 may generate the spatial decomposition tree 520 by recursively decomposing the extended fill region box 510 via power-of-two boxes and assign nodes in the spatial decomposition tree 520 that correspond to the power-of-two boxes.

To explain further, the decomposition engine 110 may decompose the extended fill region box 510 into partitions of a largest power-of-two box used to spatially decompose the fill region 220. In this example, the decomposition engine 110 decomposes the extended fill region box 510 into three (3) different 8×8 power-of-two-boxes, and in doing so, may assign (e.g., insert) three (3) nodes in the spatial decomposition tree 520 to represent the three (3) different 8×8 power-of-two-boxes. Note that the decomposition engine 110 may encode any type of power-of-two box data in the nodes of the spatial decomposition tree 520, such as an identifier, location, or size of a given power-of-two box represented by a given node.

After decomposing the extended fill region box 510 into 8×8 power-of-two box partitions, the decomposition engine 110 may decompose the space of each 8×8 power-of-two box via a next smaller power-of-two box (in this case, 4×4 power-of-two boxes). In decomposing space of a power-of-two box into partitions of smaller power-of-two boxes, the decomposition engine 110 may insert child nodes into the spatial decomposition tree 520 to represent each of the smaller power-of-two boxes. Thus, for a given node of the spatial decomposition tree 520 that represents a given 8×8 power-of-two box in the extended fill region box 510, the decomposition engine 110 may insert four (4) child nodes into the spatial decomposition tree 520 for the given node. Each of these child nodes may be likewise encoded with identifier, location, or size data. Then, the decomposition engine 110 may spatially decompose the 4×4 power-of-two boxes into 2×2 power-of-two boxes, and so forth. In such a manner, the decomposition engine 110 may recursively decompose space of each power-of-two box via a next smaller power-of-two box until space of the extended fill region box 510 is spatially decomposed into a smallest power-of-two box (e.g., the unit cell box 310 of the unit cell design 210).

Thus, a spatial decomposition tree 520 generated by the decomposition tree may include nodes that represent power-of-two boxes in the extended fill region box 510. A lowest level of the spatial decomposition tree 520 may include nodes that represent space covered by individual unit cell boxes 310, a next lowest level of the spatial decomposition tree 520 may represent space covered by 2×2 power-of-two boxes, and so forth. In the example of FIG. 5, the spatial decomposition tree 520 includes node identifiers, labeled as identifier values “0”, “1”, “2”, and “3”. The decomposition engine 110 may assign identifiers in any number of ways or configurations. In the specific example of a spatial decomposition tree 520 shown in FIG. 5, the 8×8 power-of-two boxes are identified in the spatial decomposition tree 520 in a left-to-right manner.

As such, the 8×8 power-of-two box identified in the spatial decomposition tree 520 with a node identifier value of “0” represents the leftmost partition/8×8 power-of-two box in the extended fill region box 510, the 8×8 power-of-two box identified in the spatial decomposition tree 520 with a node identifier value of “1” represents the center partition/8×8 power-of-two box in the extended fill region box 510, and so forth. For child nodes of power-of-two boxes smaller than the 8×8 power-of-two boxes, identifiers are sequenced from a lower left power-of-two box in the space decomposition and proceed in a counter-clockwise manner. For a given 8×8 power-of-two box, the lower left 4×4 power-of-two box is identified in the spatial decomposition tree 520 as child node “0”, the lower right 4×4 power-of-two box is identified as child node “1”, the upper right 4×4 power-of-two box is identified as child node “2”, and the upper left 4×4 power-of-two box is identified as child node “3”. This child node identifier sequencing continues as well for further space decompositions via power-of-two boxes, e.g., for 2×2 power-of-two boxes decomposed from a 4×4 power-of-two box.

After recursively decomposing space of the extended fill region box 510 via the power-of-two boxes down to 1×1 power-of-two box granularity, the spatial decomposition tree 520 may include node levels, with a given level corresponding to a particular power-of-two box size. A lowest level of the spatial decomposition tree 520 may include nodes that represent 1×1 power-of-two boxes in the extended fill region box 510, a next lowest level may include nodes that represent 2×2 power-of-two boxes in the extended fill region box 510, and so forth until a highest level that includes root node representative of the extended fill region box 510 itself.

The decomposition engine 110 may evaluate the spatial decomposition tree 520 based on the fill region 220 to specify containment of the fill region 220 in space covered by the various power-of-two boxes represented in the spatial decomposition tree 520. The decomposition engine 110 may evaluate whether power-of-two boxes represented by the nodes of the spatial decomposition tree 520 are occupied, partially-occupied, or empty with respect to the fill region 220, such occupation status may be marked or otherwise specified through an occupation flag or other node data encoded into the nodes of the spatial decomposition tree 520.

In evaluating a spatial decomposition tree for fill region containment, the decomposition engine 110 may start with a lowest level of the spatial decomposition tree, which may represent the 1×1 power-of-two boxes. In evaluating nodes of this lowest level of the spatial decomposition tree, the decomposition engine 110 may mark whether each node is occupied by the fill region 220 or not occupied by the fill region 220. In particular, the decomposition engine 110 may determine that a child node in this lowest level of the spatial decomposition tree 520 is occupied by the fill region 220 responsive to a determination that any portion of the fill region 220 overlaps space covered by a power-of-two box that corresponds to the child node. Thus, any 1×1 power-of-two box that contains or overlaps with any portion of the fill region 210 may be marked by the decomposition engine 110 as occupied in the spatial decomposition tree 520. Note that for the lowest level of the spatial decomposition tree 520, the decomposition engine 110 may only designate nodes as occupied or empty with respect to the fill region 220. Thus, 1×1 power-of-two boxes that only partially contain the fill region 220 are marked by the decomposition engine 110 as occupied even though a partially-occupied evaluation is possible for nodes in other levels of the spatial decomposition tree 520.

Upon evaluating nodes in the lowest level of the spatial decomposition tree 520, the decomposition engine 110 may further evaluate nodes of higher levels of the spatial decomposition tree 520. To do so, the decomposition engine 110 may evaluate nodes of spatial decomposition tree 520 on a level-by-level basis, starting from a lowest level in the spatial decomposition tree 520 and progressing upwards to higher levels in the spatial decomposition tree 520. For any given node in the spatial decomposition tree 520 in which all child nodes of the given node are marked as occupied, the decomposition engine 110 tree may mark the given node as occupied and remove the child nodes from the spatial decomposition tree 520. As such, the decomposition engine 110 may determine that a particular node of the spatial decomposition tree 520 is occupied by the fill region 220 responsive to a determination that each child node of the particular node is occupied by the fill region 220.

For any given node in the spatial decomposition tree 520 in which all child nodes of the given node are marked as empty, the decomposition engine 110 tree may mark the given node as empty and remove the child nodes from the spatial decomposition tree 520. The decomposition engine 110 may thus determine that a particular node of the spatial decomposition tree 520 is empty with respect to the fill region 220 responsive to a determination that each child node of the particular node is empty with respect to the fill region 220. For any given node in the spatial decomposition tree 520 in which child nodes of the given node include at least one child node marked as occupied and at least one child node marked as empty, the decomposition engine 110 may mark the given node as partially occupied and further determine not to remove any of the child nodes from the spatial decomposition tree 520.

In such a manner, the decomposition engine 110 may evaluate fill region containment for power-of-two boxes by evaluating nodes of the spatial decomposition tree 520. Such evaluation may be performed on a level-by-level basis, since evaluating and marking a node as occupied, partially-occupied, or empty may depend on the evaluation of child nodes in a lower level of the spatial decomposition tree 520. Upon completing evaluation of nodes of the different levels of the spatial decomposition tree 520, the spatial decomposition tree 520 may represent a spatial decomposition of the fill region 220 in that nodes marked as occupied in the spatial decomposition tree 520 may indicate which power-of-two boxes contain the fill region 220. This can be seen in the example shown in FIG. 5, in which the nodes of the spatial decomposition tree 520 indicate the power-of-two boxes of various location and size that contain the fill region 220. Empty nodes in the spatial decomposition tree 520 indicate portions (e.g., space) of the extended fill region box 510 that do not include the fill region 220.

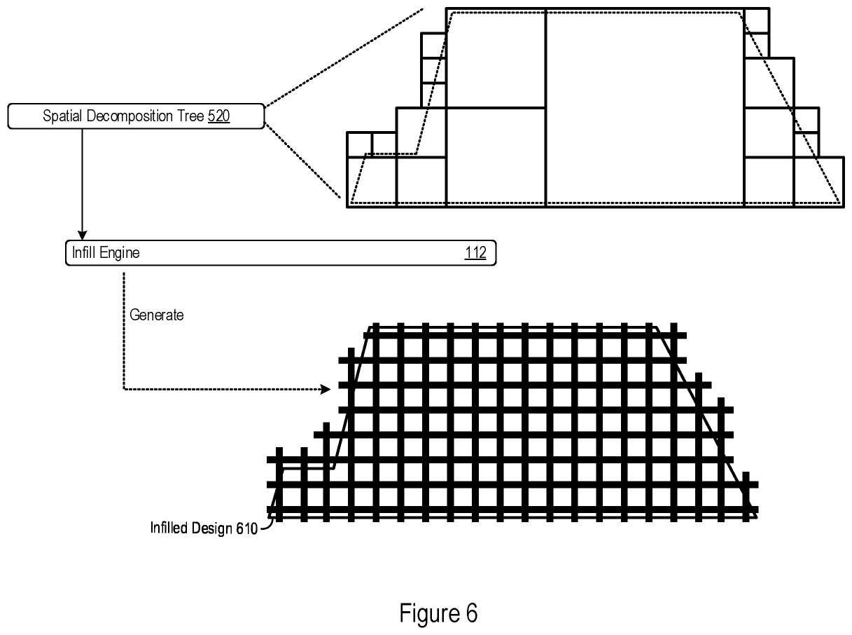

In any of the ways described herein, the decomposition engine 110 may support decomposition of a fill region 220 through generation of a spatial decomposition tree 520. The spatial decomposition tree 520 may provide a node-based representation of a spatially decomposed fill region, and may be one form that the spatially decomposed fill region 230 depicted and described in FIG. 2 may take. Through such a spatial decomposition, infill of the fill region 220 can be performed using aggregated bodies, as described next with reference to FIG. 6.

FIG. 6 shows an example generation of an infill design through a spatially decomposed infill region represented as a spatial decomposition tree. The infill engine 112 may generate an infilled design through a spatially decomposed fill region. In the example of FIG. 6, the infill engine 112 access the spatial decomposition tree 520 (or any other spatial structure) and generates the infilled design 610. As the spatial decomposition tree 520 may specify which power-of-two boxes contain the fill region 220 and may further specify box locations, the infill engine 112 may generate the infilled design 610 by placing an aggregated body of the appropriate size at the location of each power-of-two box marked in the spatial decomposition tree 520 as occupying the fill region 220. Then, the infill engine 112 may join the placed aggregated bodies to form the infilled design 610. Although displayed as untrimmed in FIG. 6, the infill engine 112 may trim portions of the unit cell design 210 that protrude beyond the border of the fill region 220 in generating the infilled design 610 as well.

By using a spatially decomposed fill region and aggregated bodies, generation of the infilled design 610 may be more computationally efficient than brute force joining of individual unit cell designs. Generation of each different size of the aggregated bodies need only be performed once, even when multiple instances of an aggregated body of a particular size are placed and used in generation of the infilled design 610, thus reducing the number of join operations that need to be performed as compared to brute force techniques. Generation of the aggregated bodies may also be performed sequentially to improve performance, and reduce the number of performed join operations. In these and various other ways, the spatial decomposition-based infill technology described herein may improve CAD computing systems by increasing the efficiency and performance of CAD infill operations via unit cell designs.

While many spatial decomposition-based infill features have been described herein through illustrative examples presented through various figures, the decomposition engine 110 or the infill engine 112 may implement any combination of the spatial decomposition-based infill technology described herein.

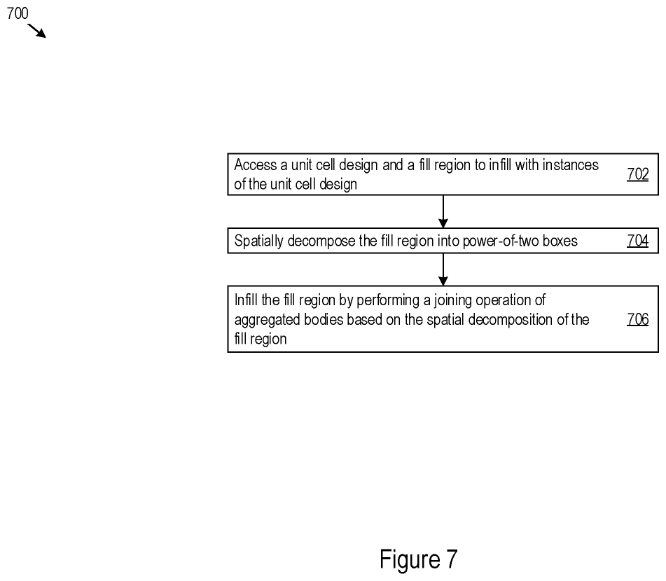

FIG. 7 shows an example of logic 700 that a system may implement to support spatial decomposition-based infills of unit cell designs for CAD objects. For example, the computing system 100 may implement the logic 700 as hardware, executable instructions stored on a machine-readable medium, or as a combination of both. The computing system 100 may implement the logic 700 via the decomposition engine 110 and the infill engine 112, through which the computing system 100 may perform or execute the logic 700 as a method to support spatial decomposition-based infills of unit cell designs. The following description of the logic 700 is provided using the decomposition engine 110 and the infill engine 112 as examples. However, various other implementation options by computing systems are possible.

In implementing the logic 700, the decomposition engine 110 may access a unit cell design and a fill region of a CAD object to infill with instances of the unit cell design (702). The decomposition engine 110 may also spatially decompose the fill region into power-of-two boxes (704), doing so in any of the various ways described herein. For example, in implementing the logic 700, the decomposition engine 110 may determine a unit cell count for each dimension of a fill region box that encloses the fill region and compute an upper power-of-two value as a function of the unit cell counts. The decomposition engine 110 may further construct power-of-two boxes and generate the aggregated bodies for the fill region based on the computed upper power-of-two value. Then, the decomposition engine 110 may spatially decompose the fill region via generation of a spatial decomposition tree, doing so in any of the ways described herein. In implementing the logic 700, the infill engine 112 may infill the fill region by performing a joining operation of aggregated bodies based on the spatial decomposition of the fill region.

The logic 700 shown in FIG. 7 provides an illustrative example by which a computing system 100 may support generation of exploded views of CAD models according to the present disclosure. Additional or alternative steps in the logic 700 are contemplated herein, including according to any of the various features described herein for the decomposition engine 110, the infill engine 112, or any combinations thereof.

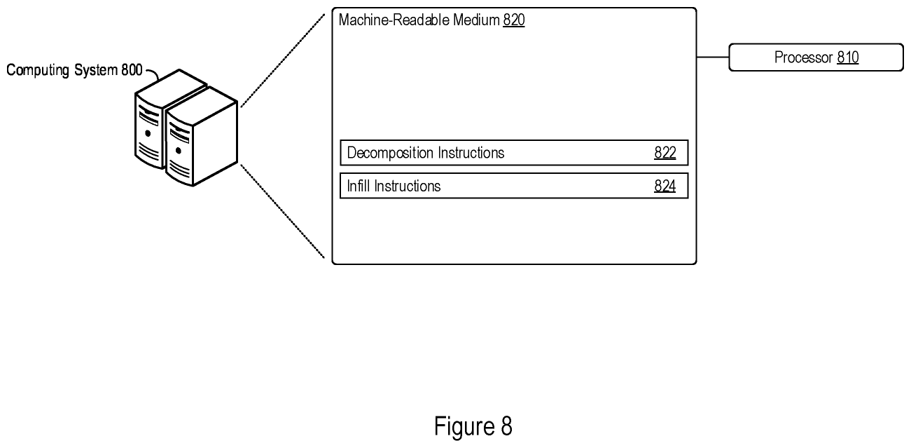

FIG. 8 shows an example of a computing system 800 that supports spatial decomposition-based infills of unit cell designs for CAD objects. The computing system 800 may include a processor 810, which may take the form of a single or multiple processors. The processor(s) 810 may include a central processing unit (CPU), microprocessor, or any hardware device suitable for executing instructions stored on a machine-readable medium. The computing system 800 may include a machine-readable medium 820. The machine-readable medium 820 may take the form of any non-transitory electronic, magnetic, optical, or other physical storage device that stores executable instructions, such as the decomposition instructions 822 and the infill instructions 824 shown in FIG. 8. As such, the machine-readable medium 820 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 800 may execute instructions stored on the machine-readable medium 820 through the processor 810. Executing the instructions (e.g., the decomposition instructions 822 and/or the infill instructions 824) may cause the computing system 800 to perform any of the spatial decomposition-based infill features described herein, including according to any of the features of the decomposition engine 110, the infill engine 112, or combinations of both.

For example, execution of the decomposition instructions 822 by the processor 810 may cause the computing system 800 to access a unit cell design and a fill region of a CAD object to infill with instances of the unit cell design as well as spatially decompose the fill region into power-of-two boxes, in which the power-of-two boxes may have dimensions equal to dimensions of the unit cell design multiplied by a power of two. Execution of the infill instructions 824 by the processor 810 may cause the computing system 800 to infill the fill region by performing a joining operation of aggregated bodies based on the spatial decomposition of the fill region. Each given aggregated body may include a number of unit cell designs equal to a power of two that are joined together to form the given aggregated body.

Any additional or alternative spatial decomposition-based infill features as described herein may be implemented via the decomposition instructions 822, infill instructions 824, or a combination of both.

The systems, methods, devices, and logic described above, including the decomposition engine 110 and the infill engine 112, may be implemented in many different ways in many different combinations of hardware, logic, circuitry, and executable instructions stored on a machine-readable medium. For example, the decomposition engine 110, the infill engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the decomposition engine 110, the infill engine 112, or combinations thereof.

The processing capability of the systems, devices, and engines described herein, including the decomposition engine 110 and the infill engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a unit cell design and a fill region of a computer-aided design object to infill with instances of the unit cell design;
spatially decomposing the fill region into power-of-two boxes, wherein the power-of-two boxes have dimensions equal to dimensions of the unit cell design multiplied by a power of two; and
infilling the fill region by performing a joining operation of aggregated bodies based on the spatial decomposition of the fill region, wherein each given aggregated body comprises a number of unit cell designs equal to a power of two that are joined together to form the given aggregated body.

2. The method of claim 1, wherein the dimensions of the unit cell design are measured as dimension of a unit cell box that encloses the unit cell design.

3. The method of claim 1, wherein spatially decomposing the fill region comprises:
determining unit cell counts for each dimension of a fill region box that encloses the fill region; and
computing an upper power-of-two value as a function of the unit cell counts.

4. The method of claim 3, further comprising generating the aggregated bodies for the fill region based on the computed upper power-of-two value.

5. The method of claim 1, wherein spatially decomposing the fill region comprises generating a spatial decomposition tree that represents the fill region, wherein nodes of the spatial decomposition tree correspond to different power-of-two boxes and wherein a given node of the spatial decomposition tree indicates whether a given power-of-two box corresponding to the given node is occupied by the fill region, partially-occupied by the fill region, or empty of the fill region.

6. The method of claim 5, wherein generating the spatial decomposition tree comprises determining that a particular node of the spatial decomposition tree is occupied by the fill region responsive to a determination that each child node of the particular node is occupied by the fill region.

7. The method of claim 5, wherein generating the spatial decomposition tree comprises determining that a child node in a lowest level of the spatial decomposition tree is occupied by the fill region responsive to a determination that any portion of the fill region overlaps space covered by a power-of-two box that corresponds to the child node.

8. A system comprising:
a processor; and
a non-transitory machine-readable medium comprising instructions that, when executed by the processor, cause a computing system to:
access a unit cell design and a fill region of a computer-aided design (CAD) object to infill with instances of the unit cell design; and
spatially decompose the fill region into power-of-two boxes, wherein the power-of-two boxes have dimensions equal to dimensions of the unit cell design multiplied by a power of two; and
infill the fill region by performing a joining operation of aggregated bodies based on the spatial decomposition of the fill region, wherein each given aggregated body comprises a number of unit cell designs equal to a power of two that are joined together to form the given aggregated body.

9. The system of claim 8, wherein the dimensions of the unit cell design are measured as dimension of a unit cell box that encloses the unit cell design.

10. The system of claim 8, wherein the instructions, when executed, cause the computing system to spatially decompose the fill region by:
determining unit cell counts for each dimension of a fill region box that encloses the fill region; and
computing an upper power-of-two value as a function of the unit cell counts.

11. The system of claim 10, wherein the instructions, when executed, further cause the computing system to generate the aggregated bodies for the fill region based on the computed upper power-of-two value.

12. The system of claim 8, wherein the instructions, when executed, cause the computing system to spatially decompose the fill region by generating a spatial decomposition tree that represents the fill region, wherein nodes of the spatial decomposition tree correspond to different power-of-two boxes and wherein a given node of the spatial decomposition tree indicates whether a given power-of-two box corresponding to the given node is occupied by the fill region, partially-occupied by the fill region, or empty of the fill region.

13. The system of claim 12, wherein the instructions, when executed, cause the computing system to generate the spatial decomposition tree by determining that a particular node of the spatial decomposition tree is occupied by the fill region responsive to a determination that each child node of the particular node is occupied by the fill region.

14. The system of claim 12, wherein the instructions, when executed, cause the computing system to generate the spatial decomposition tree by determining that a child node in a lowest level of the spatial decomposition tree is occupied by the fill region responsive to a determination that any portion of the fill region overlaps space covered by a power-of-two box that corresponds to the child node.

15. A non-transitory machine-readable medium comprising instructions that, when executed by a processor, cause a computing system to:
access a unit cell design and a fill region of a computer-aided design (CAD) object to infill with instances of the unit cell design;
spatially decompose the fill region into power-of-two boxes, wherein the power-of-two boxes have dimensions equal to dimensions of the unit cell design multiplied by a power of two; and
infill the fill region by performing a joining operation of aggregated bodies based on the spatial decomposition of the fill region, wherein each given aggregated body comprises a number of unit cell designs equal to a power of two that are joined together to form the given aggregated body.

16. The non-transitory machine-readable medium of claim 15, wherein the instructions, when executed, cause the computing system to spatially decompose the fill region by:
determining unit cell counts for each dimension of a fill region box that encloses the fill region; and
computing an upper power-of-two value as a function of the unit cell counts.

17. The non-transitory machine-readable medium of claim 16, wherein the instructions, when executed, further cause the computing system to generate the aggregated bodies for the fill region based on the computed upper power-of-two value.

18. The non-transitory machine-readable medium of claim 15, wherein the instructions, when executed, cause the computing system to spatially decompose the fill region by generating a spatial decomposition tree that represents the fill region, wherein nodes of the spatial decomposition tree correspond to different power-of-two boxes and wherein a given node of the spatial decomposition tree indicates whether a given power-of-two box corresponding to the given node is occupied by the fill region, partially-occupied by the fill region, or empty of the fill region.

19. The system of claim 18, wherein the instructions, when executed, cause the computing system to generate the spatial decomposition tree by determining that a particular node of the spatial decomposition tree is occupied by the fill region responsive to a determination that each child node of the particular node is occupied by the fill region.

20. The system of claim 18, wherein the instructions, when executed, cause the computing system to generate the spatial decomposition tree by determining that a child node in a lowest level of the spatial decomposition tree is occupied by the fill region responsive to a determination that any portion of the fill region overlaps space covered by a power-of-two box that corresponds to the child node.
